(19) United States
(12) Patent Application Publication
(10) Pub. No.: US 2009/0248769 A1
(43) Pub. Date: Oct. 1, 2009

(54) Multiply and accumulate digital filter operations

(76) Inventor: Teck-Kuen Chua, Scottsdale, AZ (US)

Correspondence Address: TROP, PRUNER & HU, P.C., 1616 S. VOSS RD., SUITE 750, HOUSTON, TX, 77057-2631, US

(21) Appl. No.: 12/079,308

(22) Filed: Mar. 26, 2008

(51) Int. Cl. G06F 5/01; G06F 17/11; G06F 7/52

(52) U.S. Cl. 708/209; 708/300; 708/620; 708/523

(57) ABSTRACT

A multiply and accumulate engine may implement a digital filter. In some embodiments, the number of coefficients that are stored may be equal to only half of the number of filter taps that are implemented. This may be done by doing multiplications operand by operand within two data registers in a first direction and then shifting directions so that the first operand in a first register is multiplied by the last operand in another register. In some embodiments, the multiply and accumulate engine may be implemented as a two cycle engine wherein in the first stage, multiply and accumulate operations are implemented and then stored into a register. In a second stage and a second cycle, the results stored in the register are further accumulated.

### BACKGROUND

This relates generally to multiplication and accumulate operations, including those performed by stand alone devices and as part of a digital signal processor.

In the course of implementing digital filters, such as finite impulse response (FIR) and infinite impulse response (IIR) filters, complex multiplications and additions may be undertaken on large samples. Generally, in multiply and accumulate operations, a relatively large number of coefficients must be stored. For example, in a 128 tap filter, 128 coefficients are stored, including 64 coefficients that are essentially the same, but in reverse order, as the other 64 coefficients.

### BRIEF DESCRIPTION OF THE DRAWINGS

FIG. 1 is a depiction of a digital signal processor in the form of a design file in accordance with one embodiment of the present invention;

FIG. 2 is a depiction of the multiply and accumulate operations that may be implemented in one embodiment by the state registers 18, register files 16, and execution units 20 in the digital signal processor shown in FIG. 1;

FIG. 3 is a depiction of a first stage of multiply and accumulate operation on two registers as an example, in accordance with one embodiment of the present invention;

FIG. 4 is a depiction of the second stage of a multiple and accumulate operation in accordance with one embodiment of the present invention;

FIG. 5 is a depiction of the reverse coefficients multiply and add instruction in accordance with one embodiment of the present invention;

FIG. 6 shows a load register operation in accordance with one embodiment of the present invention;

FIG. 7 shows the insertion of a sample into a DR_hold register and the insertion of a sample from a DR_hold register into a data register in accordance with one embodiment of the present invention;

FIG. 8 shows the simultaneous insertion of two samples into a DR_hold 2 register and the insertion of two samples into data registers in accordance with one embodiment of the present invention;

FIG. 9 is a depiction of the storing of a DR register operation in accordance with one embodiment of the present invention;

FIG. 10 is a flow chart for one embodiment; and

FIG. 11 is a system depiction for one embodiment.

### DETAILED DESCRIPTION

In accordance with some embodiments of the present invention, multiply and accumulate operations associated with finite impulse response or infinite impulse response filters are implemented. In some embodiments, these filters may be stand alone filters and, in other embodiments, they may be part of a digital signal processor. In some embodiments, rather than store the coefficients for each tap of a digital filter, only half of the coefficients may be stored for multiplication purposes and those coefficients may be multiplied in a reverse multiplication technique which avoids the need to store the entire set of coefficients.

In addition to storing a set of operands, such as delay line samples, in only one set of registers, one or more registers may be used to temporarily store operands when they are shifted out of the registers in some embodiments.

Also, in some embodiments, two stages of multiply and accumulate operations may be done. In a first stage, corresponding to a first cycle, a plurality of multiplications and reverse coefficient multiplications may be implemented, together with a first set of additions. Then, in a second stage, corresponding to a second cycle, the sums created in the first stage may be accumulated.

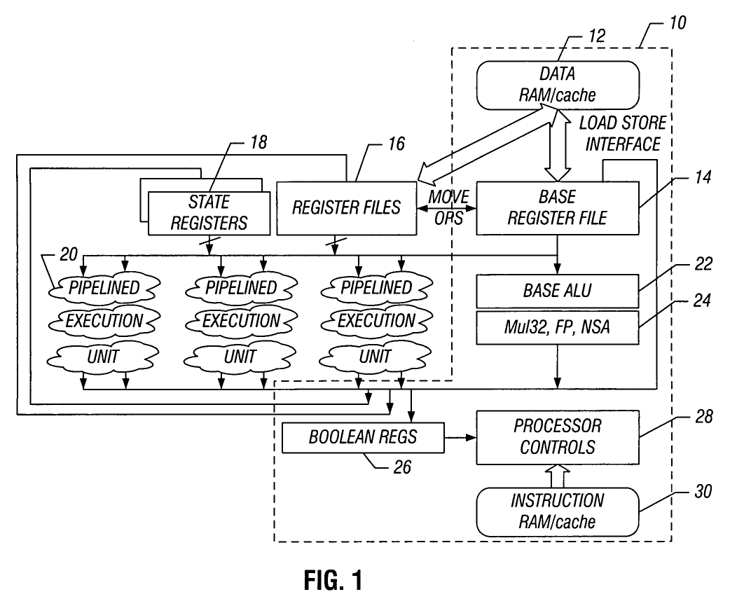

Referring to FIG. 1, in accordance with one embodiment, a digital signal processor may be formed of a base digital signal processor 10. For example, various companies provide base digital signal processor designs which then can be extended by the user. Generally, the user supplies the information for the extension. Then, the base digital signal processor design company supplies the files needed to actually produce the digital signal processor with the extension.

In the embodiment shown in FIG. 1, the base digital signal processor 10 includes a data random access memory/cache 12 and an instruction random access memory/cache 30. A base register file 14 includes the base registers that may be used by the extension, but are also available for basic digital signal processing operations. Similarly, a base arithmetic logic unit 22 may be concluded within the base digital signal processor 10. A multiplier, floating point unit, and normalized shift amount (NSA) module 24 may also be provided. Boolean registers 26 may be provided to handle the results of pipelined execution units 20. The output of the boolean registers 26 is provided to processor controls 28.

The extension may include state registers 18 and register files 16. These basically include the extension to do additional functions over what the base register file 14 may accomplish. Thus, as one example, in the designs provided by Tensilica Corporation (Santa Clara, Calif. 95054), Tensilica Instruction Extension (TIE) state registers may be used as the registers 18 and TIE register files may be used as the registers 16.

However, the present invention is in no way limited to the use of design files from Tensilica Corporation or to any particular digital signal processor architecture or, for that matter, even to the use of a digital signal processor.

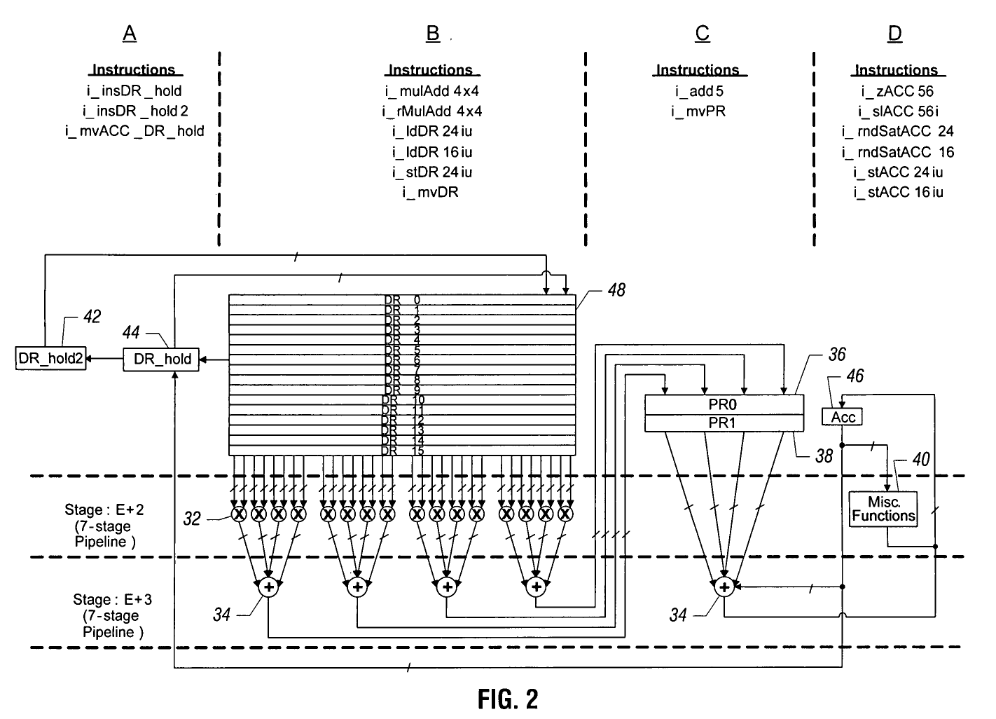

Referring now to FIG. 2, the overall layout of the multiply and accumulate device is depicted. The layout may be divided into four units, indicated as A, B, C, and D. At the top in FIG. 2, the instructions used by a unit aligned beneath the instructions are listed. Thus, the first unit A uses the DR_hold2 register 42 and DR_hold register 44. These registers temporarily hold data when rotating from and to register files (called data registers or DR registers) 48 in unit B. For example, a 368-bit DR register file 48 has a capacity that is too wide for normal data buses. To avoid the need for a plurality of cycles to transfer the data, data from the register files 48 may be cycled out to the registers 42 and 44 and then circulated back at the appropriate time (or discarded).

The unit B includes the DR registers 48 which hold coefficients or operands, such as delay line values, to be multiplied. In the illustrated embodiment, there are 16 such registers in the register files 48. Each register in the register file 48, in one embodiment, may include 16 24-bit operands to create a 384-bit register file. But other register file sizes, operand numbers, and number of register files may be utilized as well.

Below the register files 48 are the multipliers 32. The multipliers 32 then feed adders 34. Thus, the unit B implements a first stage of multiplication and accumulation. The unit C completes the operation. In other words, the instructions are divided in two such that, in a first stage, there is a multiply and accumulate and in a second stage and the subsequent cycle, the sums created in the first stage are accumulated. The multiply and add may occur over two cycles (E+2, E+3), but when the first stage is pipelined with the second stage, the average throughput is near one cycle per 16 multiply-add operations, in some embodiments.

Finally, under D, the final accumulation of the results is achieved.

A plurality of instructions are listed and associated with each of the units A-D. An explanation of the operation of these instructions is provided. However, it should be understood that the present invention is not in any way limited to the specific instructions, the specific instruction names, or the specific way each instruction operates. The first instruction under A is i_insDR_hold. It causes the contents of the DR_hold register 44 to be inserted into a DR register 48. The next instruction is i_insDR_hold2. It does the same thing with respect to both the DR_hold2 register 42 and DR_hold register 44. The final instruction under unit A is i_mvACC_DR_hold. It moves bits of the bit accumulator 46 in unit D to the DR_hold register 44.

The instructions in unit B are responsible for the multiply and accumulate operations. The first listed instruction is i_mulAdd4×4. It is responsible for half of the coefficient multiply and accumulate operation with four sets of four multiplications indicated at multipliers 32 in FIG. 2, together with the addition of the products of each set of four multiplications in a first stage. The instruction i_rMulAdd4×4 is the reverse coefficient multiply and add operation that accomplishes the other half of the coefficient multiply and accumulate operation. It does 16 multiplies with reversed coefficients and four summations of four products each.

The next instruction is i_ldDR24iu. It loads 24 bits of data into a DR register 48 and pre-increments a register, ar, in the base digital signal processor 10 file 14 by an immediate offset before a load. While an embodiment is illustrated using pre-incrementing, post-incrementing may be used as well.

The next instruction under unit B is i_ldDR16iu, which loads 16 bits of data into a DR register 48 and, in one embodiment, pre-increments the base digital signal processor 10 register file 14 ar by an immediate offset before loading.

The instruction i_stDR24iu stores 24 bits of data in a DR register 48 and pre-increments the base digital signal processor register, ar, by an immediate offset before storing.

The final instruction is i_mvDR. It moves operands from a DR register 48 to another DR register 48.

The instructions in unit C include i_add5, which sums the contents of a register file 36 or 38 with the contents of the accumulator 46. The instruction i_mvPR moves the results between register 36 and register 38.

The instructions in unit D include i_zACC56 that zeros the accumulate register 46. The next instruction, i_slACC56i, left shifts the values in accumulator 46 by a certain number of bits indicated by an immediate value. The instruction i_rndSatACC24 rounds and saturates the contents of the register 46 into a 24-bit result. i_rndSatACC16 does the same thing except it rounds and saturates into a 16-bit result. The instruction i_stACC24iu stores 24 bits in the accumulator 46 and pre-increments the base register value ar by an immediate offset before storing. i_stACC16iu stores 16 bits of the register 46 and pre-increments ar by an immediate offset before storing.

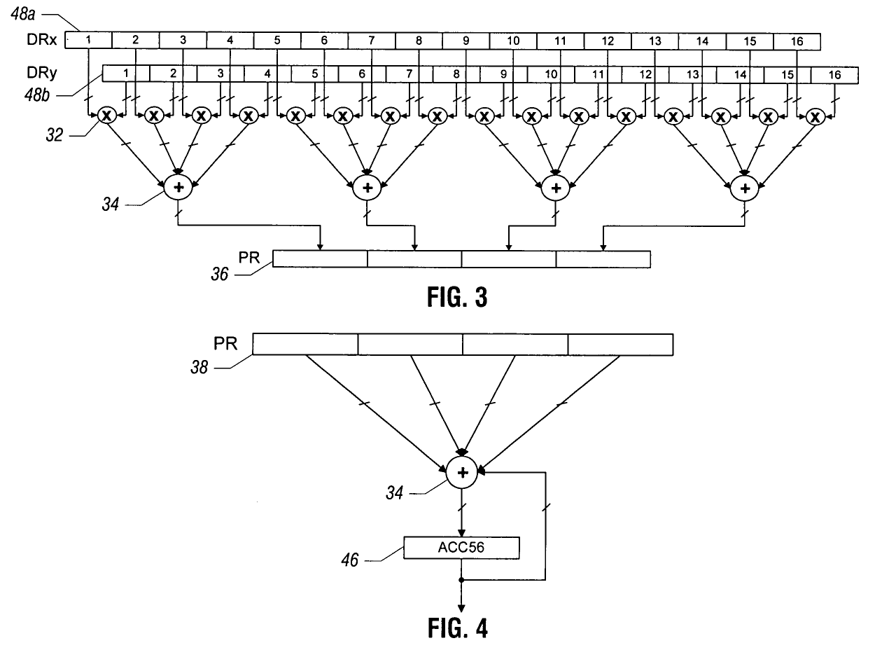

The operation of the first stage (Unit B) of multiply and accumulate is shown in FIGS. 3 and 4. In this case, two example registers 48a and 48b are being multiplied together as shown in FIG. 3. The register files 48a and 48b may be any two registers in register files 48 of the total DR registers. The operation with two registers 48a and 48b is shown only as an example. Each register 48 includes 16 operands. Thus, the first operand of the register 48a is multiplied by the first operand in the register 48b, as indicated. Likewise, the second operands are multiplied and the third operands are multiplied and so on. Then, the results of the operations of the first, second, third, and fourth operand multiplications are added together by the adder 34 and put into a first location in the PR register 36. The same thing happens with each successive set of four multiplication products and the results are placed in successive locations in PR register 36.

The operands in each of the locations in the PR register 36 or 38 are added together and accumulated in the accumulator 46.

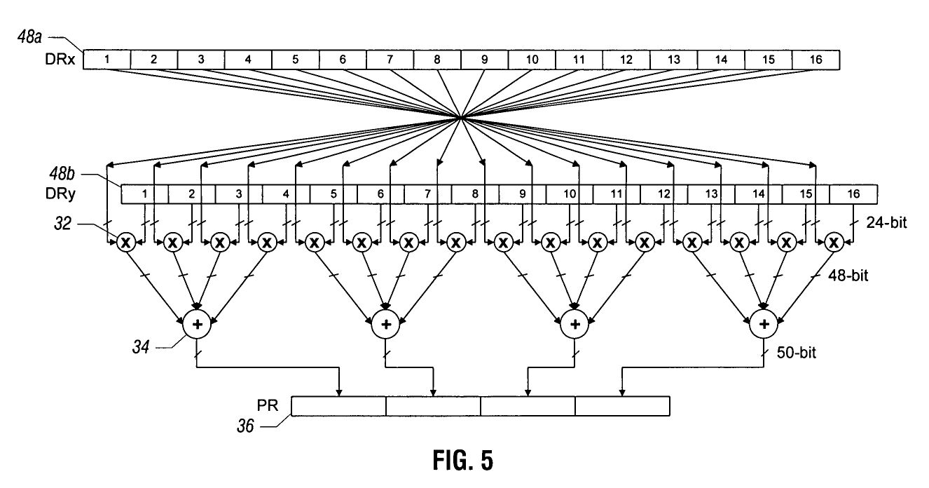

Referring to FIG. 5, at the same time that the multiplications are being done in unit B of the first stage, a set of reverse coefficient multiplications also occur. In the reverse multiplication process, the last operand, such as operand 16, in the register 48a is multiplied by the first operand in the register 48b. In other words, the leftmost operand in the register 48a is multiplied by the rightmost operand in the register 48b and vice versa. Filter operations, such as FIR filters, generally involve two halves of coefficients and in the second half, the filter coefficients are the same as the first half but in reverse order. By doing the reverse coefficient multiplication, the need to store the full set of coefficients for all the taps of a filter can be avoided. Instead, a number of coefficients equal to half the number of taps may be stored. This feature significantly reduces the amount of internal registers needed to store coefficients in some embodiments.

By splitting the large number of multiply and add operations into two independent but related instructions (one in unit B and one in unit C), speed may be increased in some embodiments.

The intermediate result may be temporarily stored in one of two PR registers 36 or 38. The two-entry PR register file realizes pipelining of the two independent instructions that perform the multiply-add operations to increase execution throughput in some embodiments.

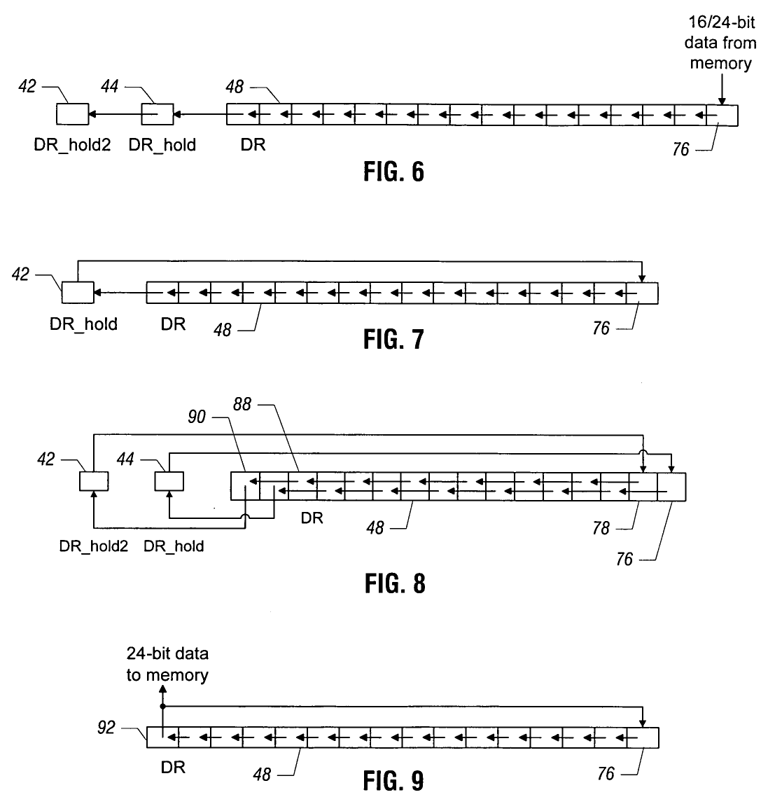

FIGS. 6-9 show the operation of the registers 44 and 42. The custom load operations and insert DR_hold2 operations facilitate shifting of samples in delay lines stored in the registers 48. FIG. 6, shows the load DR register operation which corresponds to the instructions i_ldDR24iu and i_ldDR16iu. A 16 or 24-bit data from memory is loaded into the rightmost operand location 76 of a DR register 48. This causes each of the operands to shift to the left by one place within the DR register 48. The leftmost operand shifts out into the DR_hold register 44 and the operand previously in the DR_hold register 44 is shifted to the DR_hold2 register 42. The contents of the DR_hold2 register 42 are shifted out. The shifted out contents could be discarded (e.g. in the load operation, the original content of a DR_hold2 register may be discarded) or, as shown in FIG. 2, it could be shifted back into a DR register 48.

Referring next to FIG. 7, the insert DR_hold operation implements the instruction i_insDR_hold DR. In this case, the contents of the DR_hold register 42 are shifted back into the rightmost location of the DR register 48. The operand at the leftmost location of the DR register 48 shifts into DR_hold.

In FIG. 8, the i_insDR_hold2 DR instruction causes the contents of DR_hold2 register 42 to be shifted back to the location 78 which is the second location from the rightmost end of the DR register 48. At the same time, the contents of the DR_hold register 44 are shifted to the rightmost location 76 within the DR register 48. The operands at locations 90 and 88 shift into DR_hold2 and DR_hold registers respectively.

Finally, FIG. 9 shows the instruction i_stDR24iu. It stores the 24 bit of data of a DR register 48 and pre-increments the base digital signal processor register ar by an immediate offset before storing. The contents of the leftmost location 92 in the DR register 48 may then be stored to external memory.

As an example of the operation of the multiply and accumulate unit, shown in FIG. 2, the assembly code for 128-tap finite impulse response decimator filter is illustrated. The following assembly code illustration is simply one example of one way the multiply accumulator could be utilized and serves to show how the accumulator may be implemented to achieve advantages in some embodiments.

// void SRC96_48(int* in, int* out, int count, int* delay);
// Description: Decimate input sample rate by a factor of 2.
// input: a2 = input buffer pointer
// a3 = output buffer pointer
// a4 = input samples count / 2
// a5 = delay buffer pointer
// Return value: None
// Assumption: Filter coefficients were loaded into DR0, DR1, DR2, and DR3 before calling
this function.
//
SRC96_48:

| | |
|---|---|
| .frame | a1, 32 |
| entry | a1, 32 |

// Load delay line

| addi | a6, a5, −4 | // delay buffer pointer |
|---|---|---|
| movi.n | a7, 16 | // loop counter |
| loop | a7, .LBB2_ld_dlay2 | |
| i_ldDR24iu | DR4, a6, 4 | // DR4 = delay15 .. delay0 |
| i_ldDR24iu | DR5, a6, 4 | // DR5 = delay31 .. delay16 |
| i_ldDR24iu | DR6, a6, 4 | // DR6 = delay47 .. delay32 |
| i_ldDR24iu | DR7, a6, 4 | // DR7 = delay63 .. delay48 |
| i_ldDR24iu | DR8, a6, 4 | // DR8 = delay79 .. delay64 |
| i_ldDR24iu | DR9, a6, 4 | // DR9 = delay95 .. delay80 |
| i_ldDR24iu | DR10, a6, 4 | // DR10 = delay111 .. delay96 |
| i_ldDR24iu | DR11, a6, 4 | // DR11 = delay127 .. delay112 |

.LBB2_ld_dlay2:

| addi | a3, a3, −4 | | // output buffer pointer |
|---|---|---|---|
| addi | a6, a2, −4 | | // input buffer pointer |
| loop | a4, .LBB3_src96_48_end | | |
| i_zACC56 | | | // clear accumulator |
| i_ldDR24iu | DR4, a6, 4 | | // load input sample |
| i_ldDR24iu | DR4, a6, 4 | | // load input sample |
| {i_insDR_hold2 | DR5; | i_mulAdd4×4 | PR0, DR0, DR4; nop} |
| {i_insDR_hold2 | DR6; | i_mulAdd4×4 | PR1, DR1, DR5; i_add5 PR0} |
| {i_insDR_hold2 | DR7; | i_mulAdd4×4 | PR0, DR2, DR6; i_add5 PR1} |
| {i_insDR_hold2 | DR8; | i_mulAdd4×4 | PR1, DR3, DR7; i_add5 PR0} |
| {i_insDR_hold2 | DR9; | i_rMulAdd4×4 | PR0, DR3, DR8; i_add5 PR1} |
| {i_insDR_hold2 | DR10; | i_rMulAdd4×4 | PR1, DR2, DR9; i_add5 PR0} |
| {i_insDR_hold2 | DR11; | i_rMulAdd4×4 | PR0, DR1, DR10; i_add5 PR1} |
| {nop; | | i_rMulAdd4×4 | PR1, DR0, DR11; i_add5 PR0} |

| | | |
|---|---|---|
| i_add5 | PR1 | |
| i_slACC56i | 1 | // convert to fractional products by << 1 |
| i_rndSatACC48 | | |
| i_stACC24iu | a3, 4 | // store output sample |

.LBB3_src96_48_end:
// store delay line
// a5 = points to the first sample in the delay buffer
// a7 = 16
// NOTE: The order we store the delay samples MUST be identical to the order we load them.

| addi | a6, a5, −4 | // delay buffer pointer |
|---|---|---|
| loop | a7, .LBB4_st_dlay2 | |
| i_stDR24iu | DR4, a6, 4 | // DR4 = delay15 .. delay0 |
| i_stDR24iu | DR5, a6, 4 | // DR5 = delay31 .. delay16 |
| i_stDR24iu | DR6, a6, 4 | // DR6 = delay47 .. delay32 |
| i_stDR24iu | DR7, a6, 4 | // DR7 = delay63 .. delay48 |
| i_stDR24iu | DR8, a6, 4 | // DR8 = delay79 .. delay64 |
| i_stDR24iu | DR9, a6, 4 | // DR9 = delay95 .. delay80 |
| i_stDR24iu | DR10, a6, 4 | // DR10 = delay111 .. delay96 |
| i_stDR24iu | DR11, a6, 4 | // DR11 = delay127 .. delay112 |

.LBB4_st_dlay2:

| | |
|---|---|
| retw.n | // return to caller |

The decimator filter decimates the samples by two. Thus, one of every two samples is effectively discarded to reduce in half the number of samples, as explained in the comment on the second line of the assembly code. As indicated by the comments at line 28 on page 12 to line 5 on page 13, infra, some processing that has already been done at the stage depicted above. The base digital signal processor register a2 has already received the input buffer pointer, the base digital signal processor register a3 has been set up to hold the output buffer pointer, the base digital signal processor register a4 has the number of input samples count divided by two. This sample must determine the number of times that the code shown above will be iterated. Thus, if there are a hundred input samples, there would be 50 iterations. The base digital signal processor register a5 holds the delay buffer pointer. The comment on page 13, lines 4-5 indicates that filter coefficients have already been loaded into the registers DR0-DR3 before calling this function.

The first thing that is done is to load the delay lines. The delay lines store the previous history of the sample. Each of the registers 48, labeled DR4-DR11, will be loaded with delay lines, as indicated by the comments in lines 10-20 et seq. on page 13, in the rightmost column. Initially, the delay buffer pointer is set up by the instruction addi. Then the instruction movi.n is used to iterate the sequence 16 times. The sequence that is iterated is the set of code all the way down to the line .LBB2_ld_dlay2:. a7 indicates a base digital signal processor register holding the counter for how many times the loop will be iterated. This is indicated in the next line of code (line 26 on page 13, infra, associated with the word “loop.”)

Then, in line 30 on page 13, the instruction i_ldDR24iu is used to load the samples of the delay lines. This is done by getting the value in the base digital signal processor register a6 which contains a 32-bit address of the delay line and incrementing by four (since this is a pre-increment engine). Thus, the register DR4 is loaded with the delay lines 0-15, found using the incremented addresses in the base DSP register a6. The same operation occurs for DRs 4-11. Basically what happens is 24-bit data operands are loaded into the DR4-11 registers 48, shown in FIG. 2.

After the delay line loading is completed, then the actual multiply and accumulate operations are done, as indicated in FIGS. 3, 4, and 5. The output buffer is set up by taking the content in base digital signal processor register a3 and subtracting 4 and storing it back in register a3. This sets up the output buffer pointer. The input buffer pointer is taken by the contents in base digital signal processor register a2 subtracting 4 and storing it back into base digital signal processor register a6. Then the loop iterates down to .LBB3_src96_{—}48 end.

The clear accumulator instruction is accomplished, followed by the load input sample instruction. Two samples are loaded for decimation so that, although two samples are loaded, only one sample will actually be computed in the final output result. The input sample to be loaded is found using the address in base digital signal processor register a6, incrementing by 4, and storing in DR4. Thus, two samples are loaded into DR4. Then the multiplication begins. It should be noted that in the multiplication, up to three instructions may be simultaneously implemented at the same time. In the first line, only two instructions are implemented at the same time because the rightmost column has a no operation (NOP). The first operation is i_insDR_hold2, which is implemented for DR5. Another simultaneous operation is i_mulAdd4×4 which multiplies the contents of registers DR0 and DR4 and puts the results in PR0 register 36.

The next instruction does the same thing for DR6, multiplying DR1 and DR5 and putting the result in PR1 register 38. The i_Add5 operation sums the intermediate results in PR0 registers and puts it in PR0 register 36. Thus, in this step, both stages of the multiply and accumulate are accomplished. Namely, the stages corresponding to stage 1, unit B, and stage 2, unit C, are now used because there now is a result of the first stage from the previous step that can be passed to the second stage which is unit C. At the end of all of the sequencing, the i_Add5 instruction is done for PR1 to complete the multiply-accumulate operation.

Each of the instructions i_insDR_hold2 moves the leftmost two samples. For example, the first i_insDR_hold2 instruction moves the leftmost two samples in DR5 to DR_hold and DR_hold2 registers and moves the original contents of DR_hold and DR_hold2 to the rightmost locations of DR5. Every sample in DR5 moves to the left by two positions. The next i_insDR_hold2 instruction moves the contents of DR_hold and DR_hold2 to the rightmost locations of DR6, essentially, moving the leftmost samples in DR5 to the rightmost locations of DR6.

The instruction i_slAcc56i shifts the contents of the 56-bit accumulator 46 to the left by one bit to adjust the final result in the correct fixed-point representation. The next instruction rounds and saturates, as already described. The multiplication of 24×24 bit operands results in a 48 bit product. That leaves 8 bits of 56 total bits on the left for overflow. If there is overflow in the eight overflow bits, saturation creates a representation in 48 bits.

The last set of operations under the comments “store delay line” stores the newly created set of delay lines back to external memory so that these delay lines can be used in the future.

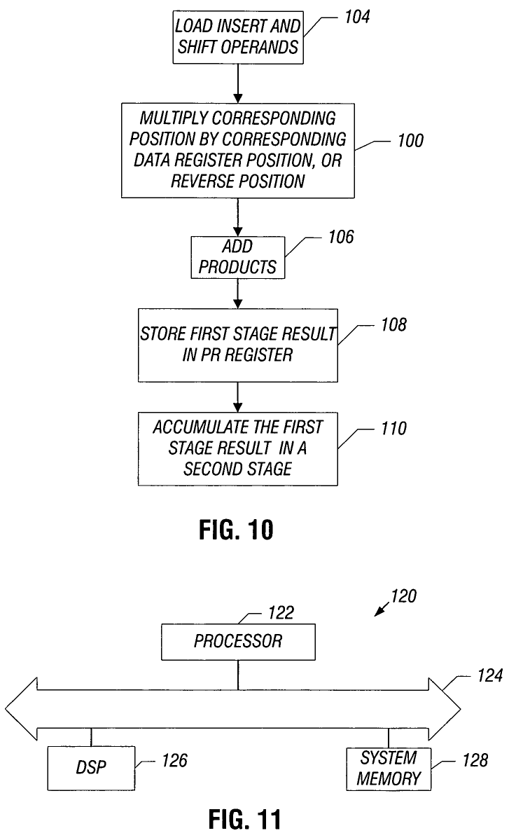

Referring to FIG. 10, a flow chart for one embodiment of the present invention is illustrated. The flow chart may be implemented by hardware, software, or firmware. In some embodiments, software may be stored in a tangible medium, such as a magnetic memory, a semiconductor memory, or an optical memory. For example, software may be stored in the instruction RAM/cache 30 in FIG. 1.

Initially, operands are loaded into data registers. Operands may be shifted, as indicated in block 104 during the load. The shifted operands may be shifted out of data registers into additional registers such as the DR_hold and DR_hold2 registers.

A first multiplication is initiated position-by-position between each set of two registers, as indicated in block 100. By “position-by-position,” it is intended to refer to the situation where an operand in a first position of one register is multiplied by an operand in a first position in another register.

A reverse multiplication is also done. This reverse multiplication may be done by multiplying an operand in a first position in one register by the operand in the last position in another register. Then the operand in the second position in the first register is multiplied by the operand in the second to last position in the other register. This continues until the last operand in the first register is multiplied by the first operand in the other register.

In some embodiments, a series of four multiplications may be done and then the results of the four multiplications may be added together in block 106. Thereafter, the results of the multiplication and accumulate operation's first stage (blocks 100, 104, and 106) may be stored, as indicated in block 108. In one embodiment, the results may be stored in a PR register 36 or 38 (FIG. 2). Finally, the results may be accumulated in block 110 from the additions in a first stage and a second stage and stored in the accumulator 46 for transfer to external memory, such as data RAM/cache 12 in FIG. 1.

Referring to FIG. 11, the system 120 may be utilized as a radio frequency transceiver, a cellular telephone, a personal computer, or a server. In some embodiments, the system may include a digital signal processor 126 which may correspond to the digital signal processor shown in FIG. 1. The digital signal processor 126 may be coupled by a bus 124 to a general purpose processor 122. The general purpose processor and the digital signal processor 126 may be coupled by the bus 124 to the system memory 128. In some embodiments, the digital signal processor 126 may include the multiply and accumulate engine to implement a finite impulse response or infinite impulse response digital filter as depicted in FIG. 2. In some embodiments, the digital signal processor 126 may be used for manipulating display elements among other tasks.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
implementing a digital filter having a number of filter taps to store a first number of coefficients equal to only half of the number of filter taps.

2. The method of claim 2 including implementing a first set of multiplications using the first number of coefficients wherein a first operand in a first register is multiplied by a first operand in another register.

3. The method of claim 2 including implementing a second set of multiplications using the first number of coefficients wherein the first operand in a first register is multiplied by the last operand in another register.

4. The method of claim 1 including splitting a multiply and accumulate operation into two independent stages wherein the first stage includes a first set of multiplications and additions and the second stage includes the additions of the sums from the first stage.

5. The method of claim 4 including storing an intermediate result of the first stage in a first register and subsequently transferring the contents of the first register to a second register for further addition in the second stage.

6. The method of claim 1 including using a plurality of data registers to store delay lines.

7. The method of claim 6 including shifting operands in said data registers.

8. The method of claim 7 including providing at least one additional register so that an operand shifted out of a data register may be stored in the additional register.

9. The method of claim 8 including providing a second additional register so that an operand shifted out of the first additional register may be stored in the second additional register.

10. The method of claim 1 including separating a multiply and accumulate operation into two stages, performing a first multiplication and addition and storing the result in a first register in the first stage and then in a second stage, performing an addition of the results from the first stage using the results in said first register.

11. An apparatus comprising:
a multiply and accumulate engine including at least two data registers having first and last operand positions, said multiply and accumulate engine to multiply the contents of the first positions in the two data registers; and
said multiply and accumulate engine to multiply the contents of the first position in one data register by an operand in the last position of the other data register.

12. The apparatus of claim 11 to simultaneously multiply operands in data registers, add the results of multiplications and additions in a prior cycle, and insert data shifted out of one of said data registers into another register.

13. The apparatus of claim 11 wherein said multiply and accumulate engine includes a first stage that does a plurality of multiplications and additions, said first stage including a first register to store the results of said multiply and accumulate operations in said first stage and said multiply and accumulate engine including a second stage to add the results stored in said first register.

14. The apparatus of claim 11 wherein said multiply and accumulate engine to shift operands in said data registers by one position.

15. The apparatus of claim 14 including an additional register to receive an operand shifted out of a data register.

16. The apparatus of claim 15 including a second additional register to receive an operand shifted out of the first additional register.

17. The apparatus of claim 16 to move operands from said first or second additional registers back into said data registers.

18. The apparatus of claim 11, wherein said apparatus is a digital filter having filter taps, said apparatus to store a number of coefficients equal to half the number of filter taps.

19. The apparatus of claim 11 including a plurality of data registers to store delay lines, sets of four multipliers to produce a product that is then added to the product produced by a second set of four multipliers.

20. The apparatus of claim 11 wherein said apparatus is a digital signal processor.

21. A tangible medium storing instructions that when executed cause a computer to:
multiply a series of operands in two data registers in a first direction and then to multiply them in the opposite direction.

22. The medium of claim 21 further storing instructions to conduct multiply and accumulate operations in two stages, one stage including multiply and accumulate operations and to store the result of the first stage in a register which is then read in the second stage to perform additional accumulate operations.

23. The medium of claim 21 further storing instructions to shift operands from position to position within a data register.

24. The medium of claim 23 wherein said operands may be shifted to one or more additional registers when they are shifted out of a data register.

25. The medium of claim 24 further storing instructions to cause operands shifted into said one or more additional registers to shift back into a data register.

26. A system comprising:
a general purpose processor; and
a digital signal processor coupled to said general purpose processor, said digital signal processor including a multiply and accumulate unit having at least two data registers, said multiply and accumulate unit to multiply a series of operands in said two data registers in a first direction and then to multiply them in the opposite direction.

27. The system of claim 26 wherein said multiply and accumulate unit implements a digital filter having a number of filter taps to store a first number of coefficients equal to only half of the number of filter taps.

28. The system of claim 27 wherein said multiply and accumulate unit includes a first stage that does a plurality of multiplications and additions, said first stage including a first register to store the results of said multiply and accumulate operations in said first stage and said multiply and accumulate engine including a second stage to add the results stored in said first register.

29. The system of claim 28, said multiply and accumulate unit to shift operands in said data registers by one position, said engine including an additional register to receive an operand shifted out of a data register.
